(19) United States
(12) Patent Application Publication
(10) Pub. No.: US 2025/0371201 A1
(43) Pub. Date: Dec. 4, 2025

(54) WEARABLE TERMINAL, LINKED DISPLAY SYSTEM, AND LINKED DISPLAY METHOD

(71) Applicant: Maxell, Ltd., Kyoto (JP)

(72) Inventor: Hiroshi NAKAMORI, Kyoto (JP)

(21) Appl. No.: 18/876,693

(22) PCT Filed: Jun. 21, 2022
(86) PCT No.: PCT/JP2022/024683

§ 371 Date: Dec. 19, 2024

(51) Int. Cl. G06F 21/84; G06V 20/52

(52) U.S. Cl. CPC G06F 21/84; G06V 20/52; G06F 2221/032

(57) ABSTRACT

From a wearable terminal to a non-wearable terminal, a control signal for causing display data being shown on a display of the non-wearable terminal to be hidden is transmitted based on information about a place or information about an information leakage medium, which causes the display data to be hidden on the display of the non-wearable terminal and also the display data to be transmitted to the wearable terminal. Upon receiving the display data from the non-wearable terminal, the wearable terminal shows the display data on a display provided in the wearable terminal.

### TECHNICAL FIELD

The present invention relates to a wearable terminal, a linked display system, and a linked display method, in particular, relates to a display technique of linking a wearable display terminal and non-wearable display terminal.

### BACKGROUND ART

As a linked display system using a plurality of displays, Patent Literature 1 describes “a first device coupled with a first display and an image sensor receives output data from a second device having a second display different from the first display. The output data represents content displayable by the second device on the second display. The first device determines, using the image sensor, a position of the second display relative to the first device and causes the first display to display content based on the output data received from the second device and the determined position of the second display relative to the first device (excerpted from Abstract)”.

### Citation List

### Patent Literature

Patent Literature 1: JP-A-2020-536311

### SUMMARY OF INVENTION

### Technical Problem

A screen of a display provided in a non-wearable terminal such as a desktop personal computer, a laptop, or a tablet is possibly seen secretly by a person other than a user of the terminal. A privacy screen for preventing this has been available, however, it allows the information being displayed on the screen to be read through the filter by the non-user depending on the angle at which the screen is seen, which requires a technique for effectively preventing the information leakage.

For responding to this need, the display technique according to Patent Literature 1 may be used, however, in Patent Literature 1, when a user makes an arbitrary selection or when it is determined that the user is looking at the PC or the mobile terminal using the HMD, the alternative display is simply carried out such that a video being displayed on the screen of the PC or the mobile terminal is shown on the screen of the HMD so as to be aligned with the position of the screen of the PC or the mobile terminal, but the viewpoint of preventing the leakage of information in accordance with a place where a user is using the non-wearable terminal such as a PC or a surrounding situation is not considered. Accordingly, the technique of simply displaying the output data from the first device on the second device cannot maintain the protection of security.

The present invention has been made in view of the circumstances described above, and an object thereof is to prevent a person who is not a user from secretly seeing a screen to improve the information security.

### Solution to Problem

In order to solve the problems described above, the present invention includes the features described in the scope of claims.

### Advantageous Effects of Invention

According to the present invention, it is possible to prevent a person who is not a user from secretly seeing a screen to improve the information security. The problems, configurations, and advantageous effects other than those described above will be clarified in the embodiment below.

### BRIEF DESCRIPTION OF DRAWINGS

FIG. 1A is a schematic configuration diagram of an alternative display system according to the present embodiment.

FIG. 1B is a schematic configuration diagram of a non-wearable terminal.

FIG. 2 illustrates the appearance of a wearable terminal, in which FIG. 2(a) illustrates an HMD and FIG. 2(b) illustrates AR glasses.

FIG. 3 is a functional block diagram of an alternative display system.

FIG. 4 illustrates a field of vision of a non-user and that of a user during alternative display using a laptop as a non-wearable terminal.

FIG. 5 illustrates a field of vision of a non-user and that of a user during alternative display using a desktop personal computer as a non-wearable terminal.

FIG. 6 illustrates a field of vision of a non-user and that of a user during alternative display using a mobile terminal as a non-wearable terminal.

FIG. 7 illustrates an example of alternative display control based on position information about a place and information about a surrounding environment as information relating to the place, in which FIG. 7(a) illustrates use in a non-private office space, FIG. 7(b) illustrates use in a user's own room, and FIG. 7(c) illustrates use in an office.

FIG. 8 illustrates an example of alternative display control in accordance with the presence or absence of a shielding object, which is a modification of alternative display control based on position information about a place and information about a surrounding environment as the information relating to the place.

FIG. 9 illustrates an example of alternative display control depending on the height of a shielding object, in which FIG. 9(a) illustrates an example of a shielding object with its height being sufficiently high, and FIG. 9(b) illustrates a field of vision of a user.

FIG. 10 illustrates an example of alternative display control depending on the length in the depth direction of a shielding object, in which FIG. 10(a) illustrates an example of a shielding object not reaching the front side, and FIG. 10(b) illustrates a field of vision of a user.

FIG. 11 illustrates an example of alternative display control in a space where a security camera is installed as an information leakage medium, in which FIG. 11(a) illustrates an example of carrying out the alternative display, and FIG. 11(b) illustrates an example of not carrying out the alternative display.

FIG. 12 illustrates a situation where a security camera is not installed in the same space as that illustrated in FIG. 11.

FIG. 13 illustrates an example of alternative display control based on a person other than a user as an information leakage medium.

FIG. 14 illustrates an example of alternative display control in a case where a non-user is present in a place farther than a first distance, in which FIG. 14(a) illustrates an example of carrying out the alternative display, and FIG. 14(b) illustrates an example of not carrying out the alternative display.

FIG. 15 illustrates an example of not carrying out alternative display in a case where a non-user is present at a place farther than a first distance.

FIG. 16 illustrates an example of a user setting screen of an alternative display function.

FIG. 17 illustrates a user setting screen of a detailed alternative display function.

FIG. 18 illustrates a group information registration setting screen.

FIG. 19 illustrates an example of alternative display control rule information.

FIG. 20 illustrates a flowchart of a flow of processing (first half) of an alternative display system according to the present embodiment.

FIG. 21 illustrates a flowchart of a flow of processing (second half) of an alternative display system according to the present embodiment.

FIG. 22 illustrates a flowchart of a flow of processing of alternative display control based on position information about a place and information about a surrounding environment as information relating to the place.

FIG. 23 illustrates a flowchart of a flow of processing of alternative display control based on a security camera as an information leakage medium.

FIG. 24 illustrates a flowchart of a flow of processing of alternative display control based on a person other than a user as an information leakage medium.

FIG. 25 illustrates a flowchart of a flow of processing of alternative display control based on a group to which a person belongs.

FIG. 26 illustrates a flowchart of a flow of processing of alternative display control based on a group to which a person belongs.

### DESCRIPTION OF EMBODIMENTS

The present invention is useful for prevention of the leakage of information being displayed on a non-wearable terminal, and thus can increase the product value of the non-wearable terminal to which the present invention is applied. Therefore, the present invention can be expected to contribute to 8.2 (Achieve higher levels of economic productivity through diversification, technological upgrading and innovation, including through a focus on high-value added and labor-intensive sectors) of the Sustainable Development Goals (SDGs) proposed by the United Nations.

Hereinafter, an exemplified embodiment of the present invention will be described with reference to the drawings. Throughout all the drawings, the same components are provided with the same reference signs, and repetitive explanation therefor will be omitted.

### Schematic Configuration of Alternative Display System

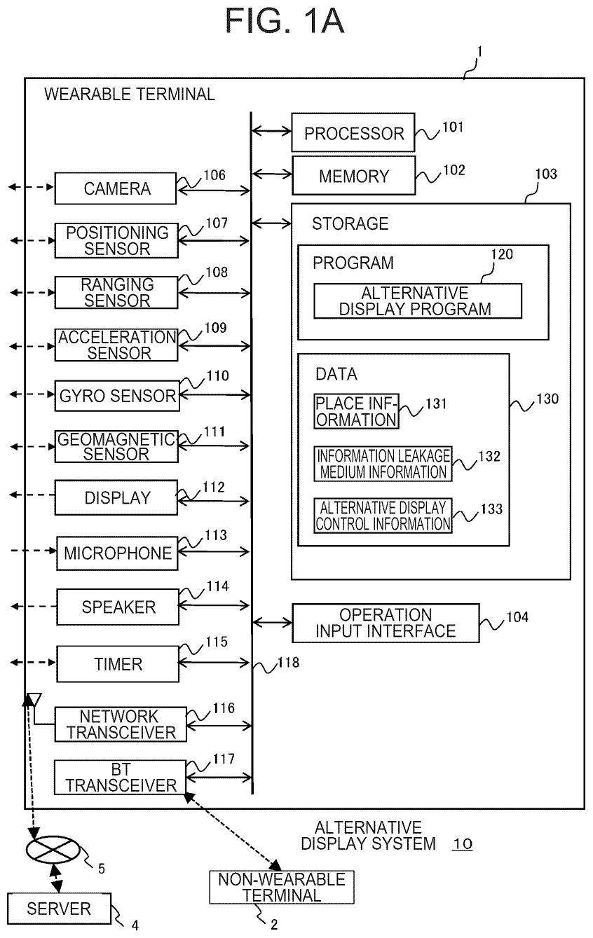

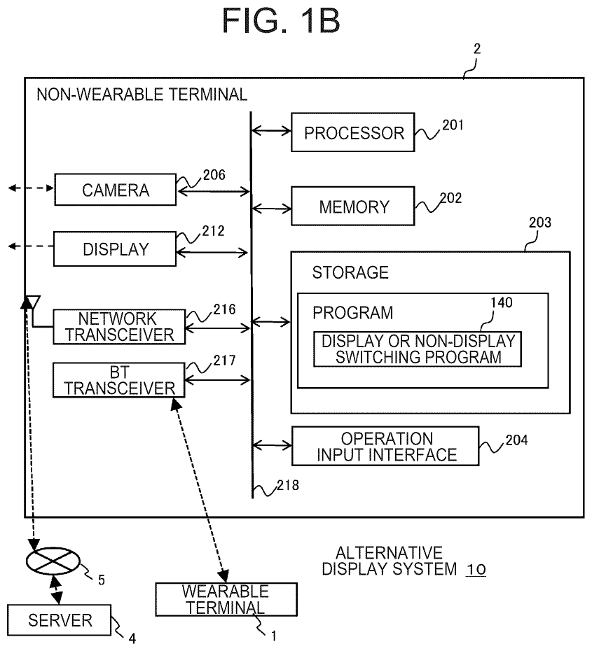

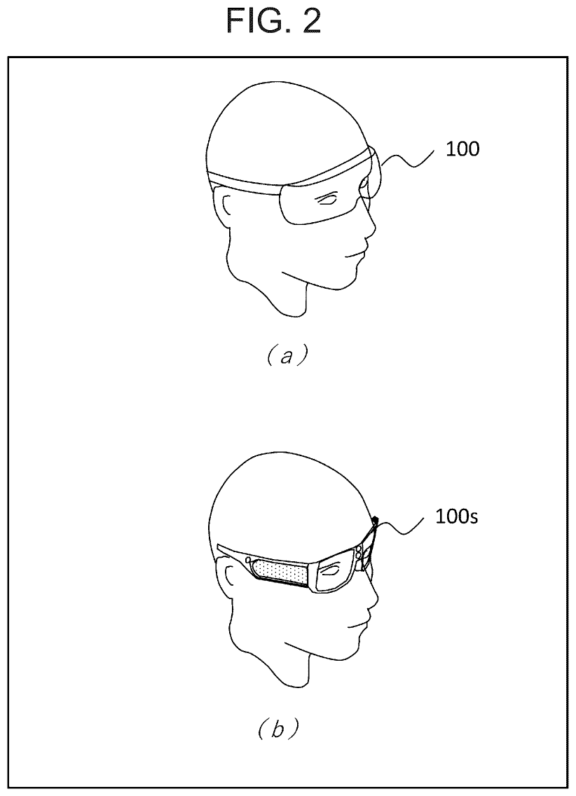

FIG. 1A is a schematic configuration diagram of an alternative display system according to the present embodiment. FIG. 1B is a schematic configuration diagram of a non-wearable terminal. FIG. 2 illustrates the appearance of a wearable terminal, in which FIG. 2(a) illustrates an HMD and FIG. 2(b) illustrates AR glasses.

An alternative display system 10 illustrated in FIG. 1A is configured with a wearable terminal 1 and a non-wearable terminal 2 which are wirelessly connected to communicate with each other. The wearable terminal 1 and the non-wearable terminal 2 may be connected wirelessly to establish communication therebetween, for example, in a direct manner by using near-field wireless communication such as Bluetooth (registered trademark) or in an indirect manner through a LAN.

The wearable terminal 1 to be used in the alternative display system 10 may be any type of terminal as long as it allows only a user wearing the wearable terminal 1 to see the screen of the wearable terminal, and for example, it may be an HMD 100 exemplified in FIG. 2(a) or AR glasses 100s exemplified in FIG. 2(b).

As illustrated in FIG. 1, the wearable terminal 1 includes a processor 101 (corresponding to a first processor), a memory 102, a storage 103, an operation input interface 104, a camera 106, a positioning sensor 107, a ranging sensor 108, an acceleration sensor 109, a gyro sensor 110, a geomagnetic sensor 111, a display 112 (corresponding to a first display), a microphone 113, a speaker 114, a timer 115, a network transceiver 116, and a BT (Bluetooth (registered trademark)) transceiver 117, and these components are connected to each other via a bus 118.

The storage 103 retains an alternative display program 120, and the processor 101 loads and stores the alternative display program 120 in the memory 102 to execute it.

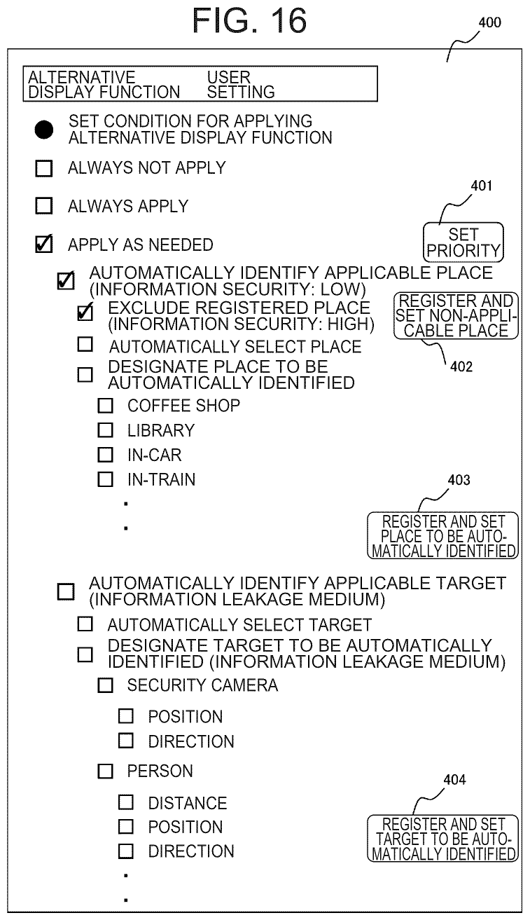

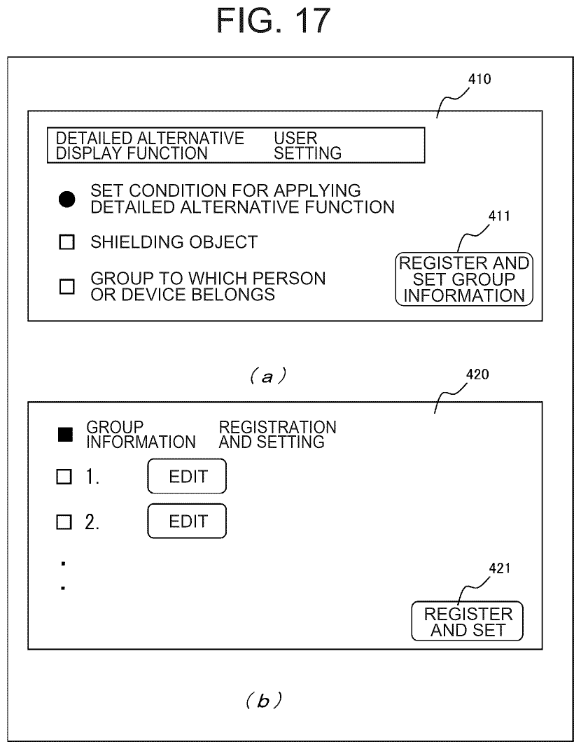

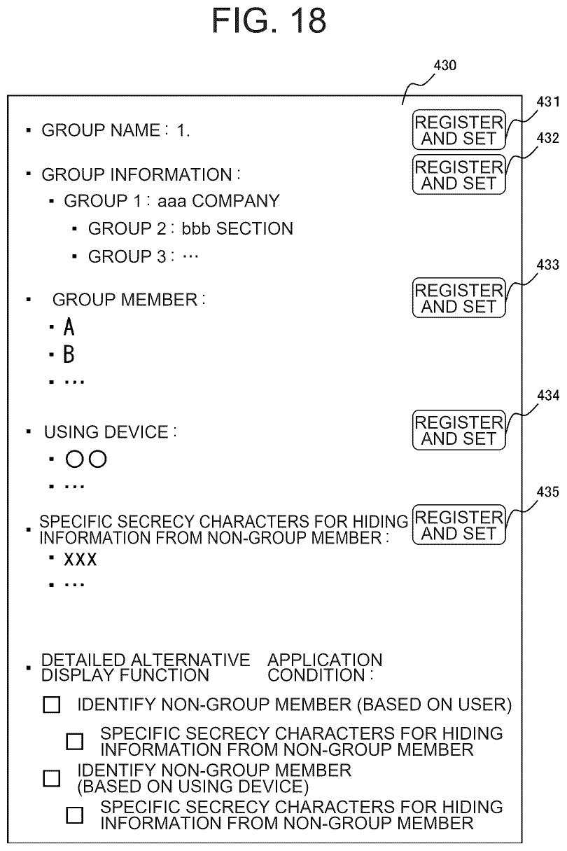

Furthermore, the storage 103 retains data 130 generated in the process and result of execution of the alternative display program 120. The data 130 includes place information 131, information leakage medium information 132, and alternative display control information 133. Each of the place information 131, the information leakage medium information 132, and the alternative display control information 133 is entered through a setting screen 400 (see FIG. 16), a user setting screen 410 (see FIG. 17(a)), a group information registration setting screen 420 (see FIG. 17(b)), and a group information details screen 430 (see FIG. 18), which will be described later.

The ranging sensor 108 is a sensor configured to output information about a distance to a real object to be measured. For example, the ranging sensor 108 may be a sensor configured to calculate a distance with respect to feature points of, for example, a contour of a real object using an image with parallax, such as a stereo camera, and output distance information. Alternatively, it may be a sensor configured to measure a distance by irradiating an object to be measured with a light beam two-dimensionally as in a Time of Flight (TOF) system.

The network transceiver 116 is a transceiver for implementing a communication function of wireless communication using a communication standard such as Wi-Fi (registered trademark). The network transceiver 116 may be connected to a server 4 via a LAN or an external network 5 so as to communicate with each other. The network transceiver 116 may download an update program from the server 4.

The BT transceiver 117 is a transceiver for Bluetooth (registered trademark), and carries out near-field wireless communication with the non-wearable terminal 2 that carries out the alternative display processing, such as a personal computer (including a laptop and a desktop personal computer), or a mobile terminal (including a smartphone and a tablet).

The display 112 is a see-through display. The user views the real world through the display 112, and sees a virtual reality object being superimposed and shown on the display 112 as if it was on the real world.

The non-wearable terminal 2 is a terminal having a screen allowing a person who is not the user of the wearable terminal 1 to be seen, and, for example, a desktop personal computer connected to a monitor, a laptop, a smartphone, or a tablet.

As illustrated in FIG. 1B, the non-wearable terminal 2 includes a processor 201 (corresponding to a second processor), a memory 202, a storage 203, an operation input interface 204, a camera 206, a display 212 (corresponding to a second display), a network transceiver 216, and a BT transceiver 217, and these components are connected to each other via a bus 218.

In the case of using a smartphone or a tablet as the non-wearable terminal 2, it further includes a ranging sensor, a positioning sensor, and the like in addition to the components described above. However, FIG. 1B illustrates neither the ranging sensor or the positioning sensor since the non-wearable terminal 2 to be used in the alternative display system 10 does not necessarily have to include them.

A display or non-display switching program 140 stored in the storage 203 is configured to, upon receiving a control signal for hiding the display data being shown or to be shown on the display 212 from the wearable terminal 1, hide the display data being shown or to be shown on the display 212 and transmit it to the wearable terminal 1.

In the present embodiment, the alternative display program 120 is installed in the wearable terminal 1, and the wearable terminal 1 determines whether to execute the alternative display control. The display or non-display switching program 140 installed in the non-wearable terminal 2 is configured to mainly execute the display control for making the display 212 of the non-wearable terminal 2 in a non-display state in response to a control signal from the wearable terminal 1.

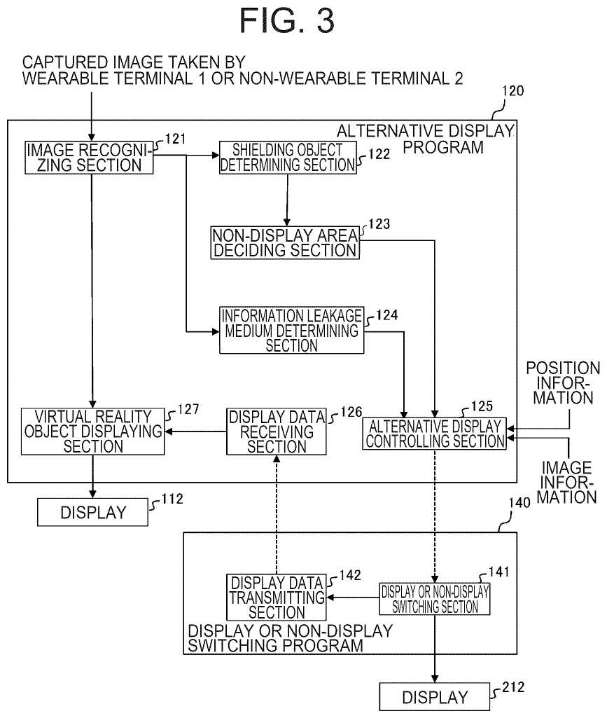

FIG. 3 is a functional block diagram of the alternative display system.

The alternative display program 120 includes an image recognizing section 121, a shielding object determining section 122, a non-display area deciding section 123, an information leakage medium determining section 124, an alternative display controlling section 125, a display data receiving section 126, and a virtual reality object displaying section 127.

The image recognizing section 121 analyzes images captured by the cameras 106, 206 mounted on the wearable terminal 1 and the non-wearable terminal 2, respectively, to carry out the subject recognition processing.

If a shielding object is captured in an image as an subject, the shielding object determining section 122 determines the height, position of arrangement, non-transparency, and the like of the shielding object.

The non-display area deciding section 123 decides an area to be hidden in accordance with the shielding object based on the result of determination made by the shielding object determining section 122.

The information leakage medium determining section 124 determines whether the subject corresponds to an information leakage medium.

The alternative display controlling section 125 starts and terminates the alternative display, and also determines whether to carry out the alternative display control based on the position information and the image information.

The display data receiving section 126 receives the display data to be shown in an alternative manner from the non-wearable terminal 2.

The virtual reality object displaying section 127 detects the position of the display 212 of the non-wearable terminal 2 based on the image captured by the camera 106 of the wearable terminal 1, and shows the display data on the display 112 of the wearable terminal 1 such that the display data is superimposed on the display 212 of the non-wearable terminal 2. This causes the display data to be shown on the display 112 as a virtual reality object.

The display or non-display switching program 140 includes a display or non-display switching section 141 and a display data transmitting section 142.

The display or non-display switching section 141 switches between a non-display state and a display state of the display 212 based on a control signal for instructing the start and termination of the alternative display provided from the wearable terminal 1.

The display data transmitting section 142 transmits the display data to be displayed in an alternative manner to the wearable terminal 1.

### Comparison of Field of Vision of Non-User and Field of Vision of User

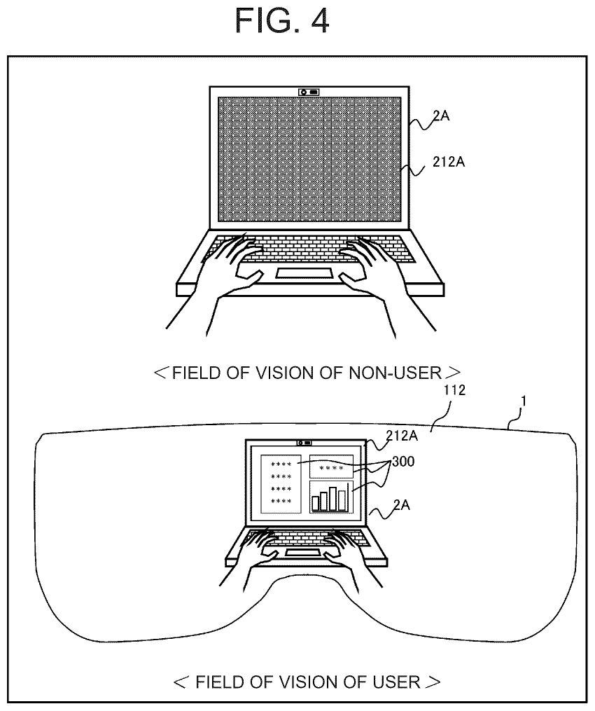

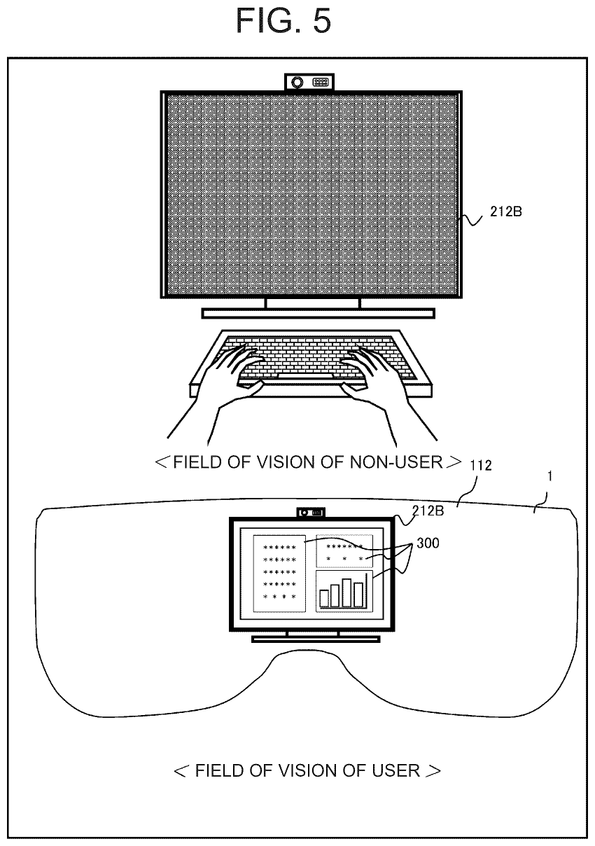

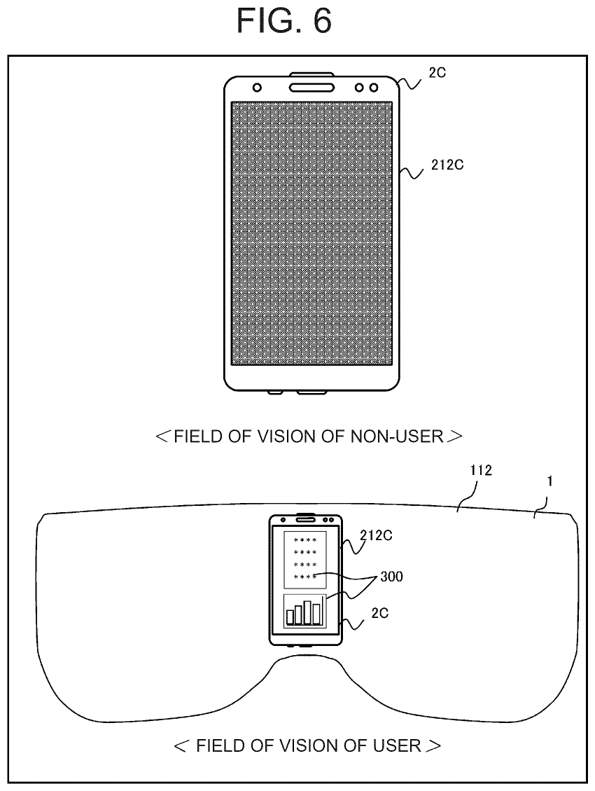

Referring to FIG. 4, FIG. 5, and FIG. 6, the field of vision of a user during the alternative display will be described. FIG. 4 illustrates the field of vision of a non-user and that of a user during the alternative display using a laptop. FIG. 5 illustrates the field of vision of a non-user and that of a user during the alternative display using a desktop personal computer. FIG. 6 illustrates a field of vision of a non-user and that of a user during the alternative display using a mobile terminal.

As illustrated in FIG. 4, during the alternative display, a display 212A of a laptop 2A is in a non-display state, where the information that the user wishes to see thereon is not displayed. Accordingly, in the field of vision of a non-user, the screen of the display 212 of the laptop 2A is in the non-display state. The laptop 2A transmits display data 300 that should have been displayed on the display 212A to the wearable terminal 1.

In the wearable terminal 1, the position of the display 212A is detected, and the display data 300 is shown on the display 112 of the wearable terminal 1 so as to be superimposed on the position where the display 212A can be seen through the display 112. Accordingly, in the field of vision of the user wearing the wearable terminal 1, the display data 300 appears as if it was being shown on the display 212A of the laptop 2A.

FIG. 5 illustrates a state during the alternative display, in which a display 212B connected to a desktop personal computer (not illustrated) that has been connected to the wearable terminal 1 so as to communicate therewith is shown on the wearable terminal 1.

FIG. 6 illustrates a state during the alternative display, in which a display 212C of a mobile terminal 2C that has been connected to the wearable terminal 1 so as to communicate therewith is shown on the wearable terminal 1.

In any case illustrated in FIG. 4, FIG. 5, and FIG. 6, the user sees the display data 300 being shown on the display 112 of the wearable terminal 1, in such a manner that the display data 300 is superimposed on the display 212 of the non-wearable terminal 2 that the user is seeing in the real world through the display 112 of the wearable terminal 1. On the other hand, the display 212 of the non-wearable terminal 2 has been made in the non-display state, which prevents a non-user from seeing the display data 300 while, for the user, it appears as if being shown on the display 212 of the non-wearable terminal 2.

### Alternative Display Control Based on Position Information About Place and Information About Surrounding Environment as Information Relating to Place

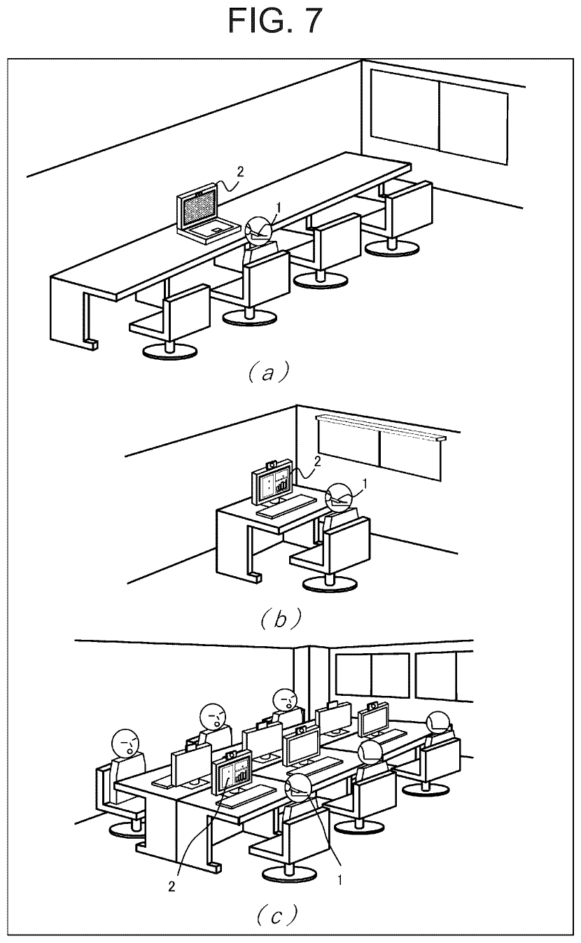

FIG. 7 illustrates an example of the alternative display control based on position information about a place and information about a surrounding environment as information relating to the place, in which FIG. 7(a) illustrates use in a non-private office space, FIG. 7(b) illustrates use in a user's own room, and FIG. 7(c) illustrates use in an office.

FIG. 7(a) illustrates an example of use in a space that has not been registered, such as a non-private office space. In this case, the alternative display is to be carried out.

FIG. 7(b) illustrates an example of use in an own room (pre-registered) and FIG. 7(c) is an example of use in an office (pre-registered). It is considered that the level of information security is high in a place such as an own room where other people do not freely enter and leave and an office which is shared with people owing the same duty of confidentiality as the user. Accordingly, acquiring position information about a place with the level of information security being high and an image showing the surrounding environment thereof using the positioning sensor 107 and the camera 106 and registering them in advance allows the alternative display function to be controlled not to be activated in a place that has been registered and to be activated in a place that has not been registered. This enables the alternative display function to be controlled based on, as the information relating to a place, the position information or image of a place that has been registered and that of a place where the user is currently present.

### Modification of Alternative Display Control Based on Position Information About Place and Information About Surrounding Environment as Information Relating To Place: Shielding Object

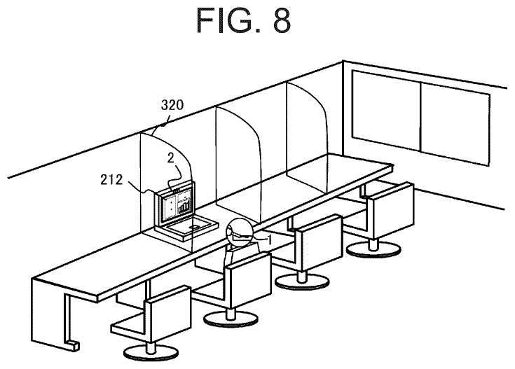

FIG. 8 illustrates an example of the alternative display control in accordance with the presence or absence of a shielding object with respect to the non-wearable terminal 2 as the information relating to the surrounding environment, which is a modification of the alternative display control based on position information about a place and information about a surrounding environment as the information relating to the place.

If a non-transparent shielding object 320, for example, a partition or a wall, is located on the left or right side of the display 212 of the non-wearable terminal 2 used by the user, the display 212 of the non-wearable terminal 2 cannot be seen from an adjacent seat (FIG. 8 explicitly illustrates the state of the display 212 of the non-wearable terminal 2 in the situation described above). In this case, the level of information security of the place where the user is present is higher than that in the case where there is no partition or wall. Thus, the image captured by the camera 106 of the wearable terminal 1 or the camera 206 of the non-wearable terminal 2 may be analyzed to determine whether a partition is located, so that the alternative display can be controlled not to be carried out in response to the determination that the shielding object 320 which prevents the display 212 from being seen is present.

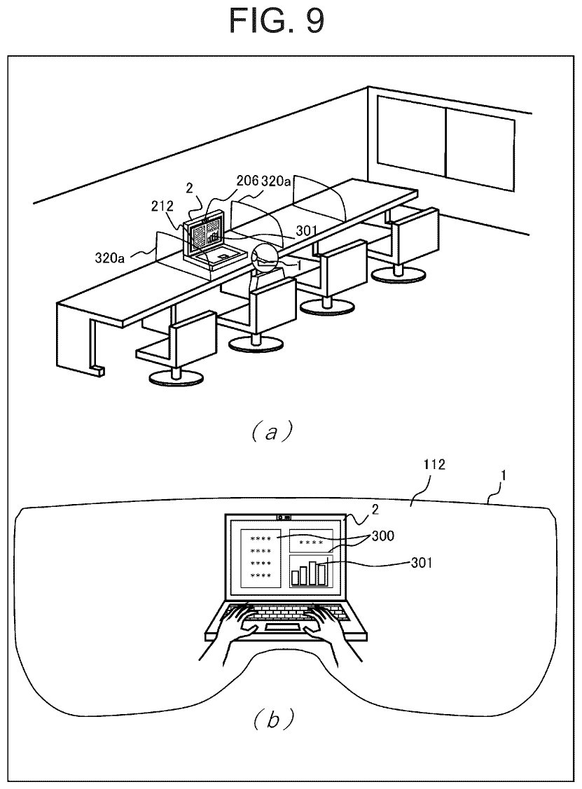

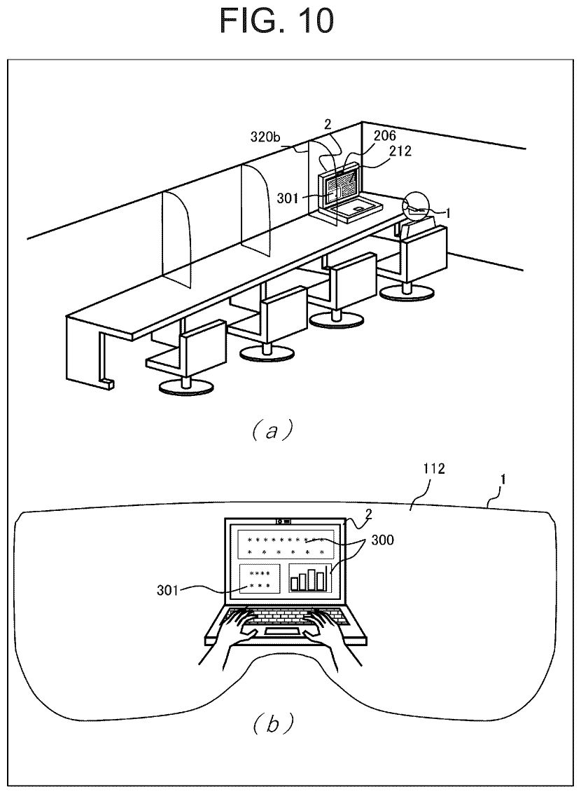

FIG. 9 illustrates an example of alternative display control depending on the height of a shielding object with respect to the non-wearable terminal 2, in which FIG. 9(a) illustrates the case where a shielding object is not sufficiently high, and FIG. 9(b) illustrates the field of vision of the user. FIG. 10 illustrates an example of alternative display control depending on the length in the depth direction of a shielding object with respect to the non-wearable terminal 2, in which FIG. 10(a) illustrates the case where a shielding object does not reach the front side, and FIG. 10(b) illustrates the field of vision of the user. Depending on the height or length in the depth direction of a shielding object, an area of the display 212 which can be seen from the outside varies (each of FIG. 9 and FIG. 10 explicitly illustrates the display 212 of the wearable terminal 2 in the situation described above), which makes the level of information security of the place different.

In the case where a non-transparent portion of a shielding 320a is low, the level of information security is higher than the case where there is no shielding object, however, the level of information security is lower than the case where the shielding object is sufficiently high. In this case, the alternative display may be carried out for an area of a screen of an application software, which corresponds to an area of the display 212 of the non-wearable terminal 2 which can be seen from the left and right. For example, in FIG. 9(a), the height of the shielding object 320a is less than the height of an upper end portion of the display 212 of the non-wearable terminal 2. In this case, a screen of an application software corresponding to an area upper than the half of the non-wearable terminal 2 is to be made hidden.

The display data 300 on the screen of the application software which has been hidden is transmitted to the wearable terminal 1 for the alternative display. As illustrated in FIG. 9(b), the screen of the application software displayed in the alternative manner on the wearable terminal 1 is seen by the user wearing the wearable terminal 1 in such a manner that the screen is superimposed and shown on the display 212 of the non-wearable terminal 2. On the other hand, an application screen 301 continues to be shown on the display 212 of the non-wearable terminal 2, and thus is not shown on the wearable terminal 1. The user sees the application screen 301 that is actually shown on the display 212 of the non-wearable terminal 2 through the display 112 of the wearable terminal 1.

In FIG. 10, the height of a partition as a shielding object 320b is equal to or more than that of an upper end portion of the non-wearable terminal 2, however, the length in the depth direction thereof is so short that the partition cannot shield a range from the front side of the desk to the center in the depth direction. In this case, the application screen 301 continues to be shown without carrying out the alternative display for the lower left of the non-wearable terminal 2 which can be shielded by the partition, however, the alternative display is to be carried out for the screen of the application software corresponding to the upper half and the right side of the display 212.

The display data 300 on the screen of the application software which has been hidden is transmitted to the wearable terminal 1 for the alternative display. As illustrated in FIG. 10(b), the screen of the application software displayed in the alternative manner on the wearable terminal 1 is seen by the user wearing the wearable terminal 1 in such a manner that the screen is superimposed and shown on the display 212 of the non-wearable terminal 2. On the other hand, an application screen 301 continues to be shown on the display 212 of the non-wearable terminal 2, and thus is not shown on the wearable terminal 1. The user sees the application screen 301 that is actually shown on the display 212 of the non-wearable terminal 2 through the display 112 of the wearable terminal 1.

As described above, the alternative display control can be carried out based on the information about the transparency and shape of a shielding object with respect to the non-wearable terminal 2, which corresponds to the information about an environment around a place where the user is operating the non-wearable terminal 2. The alternative display can be carried out for, within the display 212 of the non-wearable terminal 2, only a screen of an application software which extends across an area that is hard to be shielded due to the transparency and shape of the shielding object. If the performance of a screen, for example, an image quality, of the wearable terminal 1 such as an HMD or AR glasses is less than that of the non-wearable terminal 2 such as a PC, the alternative display may cause reduction in the usability of the non-wearable terminal 2. For this problem, limiting an area of the screen for which the alternative display is to be carried out only in a necessary portion enables both suppression of reduction in the usability of the non-wearable terminal 2 and enhancement of the information security.

### Alternative Display Control Based on Security Camera as Information Leakage Medium

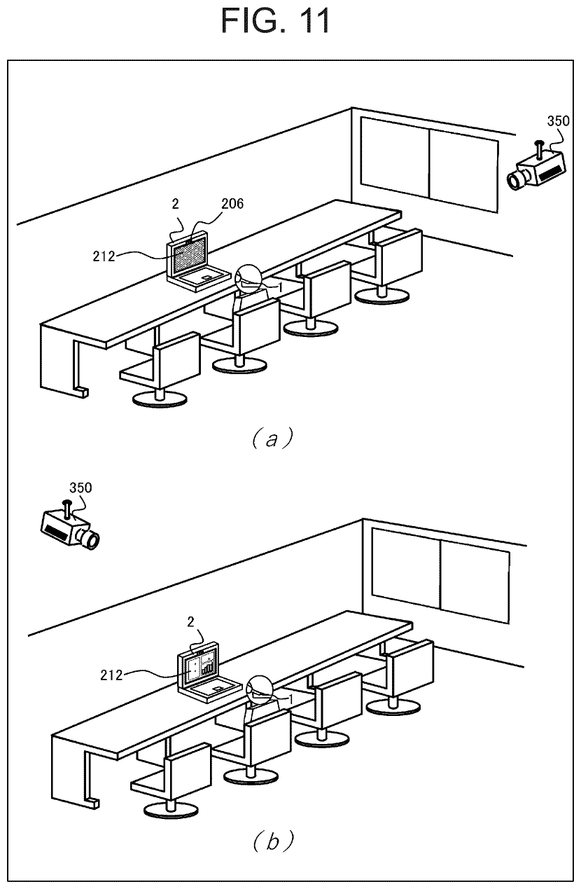

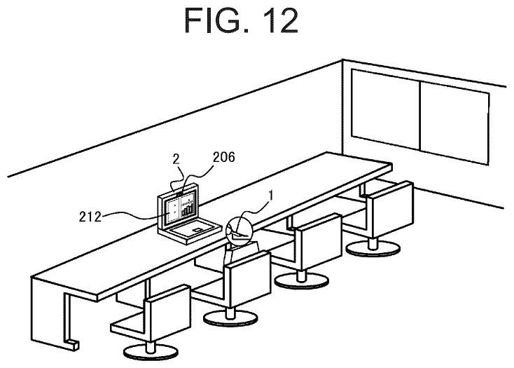

An example of the alternative display control based on the presence or absence of a security camera as the information on an information leakage medium will be described. FIG. 11 illustrates an example of alternative display control in a space where a security camera is installed as an information leakage medium, in which FIG. 11(a) illustrates an example of carrying out the alternative display, and FIG. 11(b) illustrates an example of not carrying out the alternative display. FIG. 12 illustrates a situation where the security camera is not installed in the same space as that illustrated in FIG. 11.

In each of the cases illustrated in FIG. 11(a) and FIG. 11(b), a security camera 350 is installed in a room where the user operating the non-wearable terminal 2 is present. The security camera 350 is an example of the information leakage medium.

If the screen of the display 212 of the non-wearable terminal 2 is included within an angle of view of the security camera 350, the display data being shown on the screen of the display 212 of the non-wearable terminal 2 is captured in the image by the security camera 350, which may lead to the information leakage.

Accordingly, the alternative display control can be carried out based on the presence or absence of the security camera 350 as the information about the information leakage medium.

In FIG. 11(a), the security camera 350 is captured in the image taken by the camera 206 mounted on the non-wearable terminal 2. In this case, there is a possibility that the screen of the display 212 of the non-wearable terminal 2 is captured in the image taken by the security camera 350, and thus the alternative display is to be carried out. The camera 106 of the wearable terminal 1 may be used to capture an image. In this case, the relation between the position and direction of the display 212 of the non-wearable terminal 2 and those of the security camera 350 is analyzed based on the image captured by the camera 106 and the result of measurement of distances acquired by the distance measurement sensor 108.

In FIG. 11(b), the security camera 350 is captured in the image taken by the camera 106 of the wearable terminal 1, however, the security camera 350 is not captured in the image taken by the camera 206 mounted on the non-wearable terminal 2. In this case, it can be determined that, in the direction of the security camera 350 (image capturing direction) in FIG. 11(b), the security camera 350 cannot capture the screen of the display 212, and thus the alternative display is not to be carried out.

In FIG. 12, the space illustrated therein is the same as that in FIG. 11, however, no security camera is installed. In this case, it is determined that the security camera 350 is absent in the determination as to whether the security camera 350 is present based on the image captured by the camera 206 of the non-wearable terminal 2 or the camera 106 of the wearable terminal 1, and thus the alternative display is not to be carried out.

According to the example as described above, the alternative display control can be carried out in accordance with, as the information about the information leakage medium, the presence or absence of the security camera 350 around the user or the non-wearable terminal 2, and the direction (image capturing direction) of the lens of the security camera 350.

### Alternative Display Control Based on Person Other Than User as Information Leakage Medium

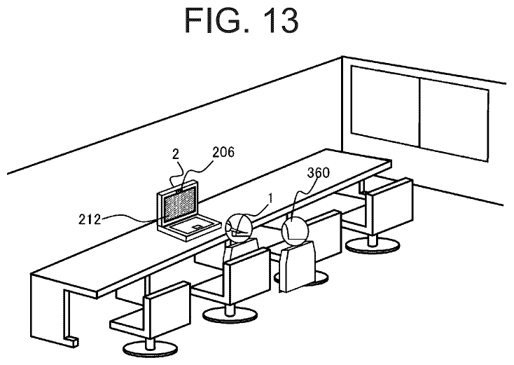

FIG. 13 illustrates an example of the alternative display control based on a person other than the user as an information leakage medium.

If a non-user 360, who is a person other than the user, is captured in an image taken by the camera 206 of the non-wearable terminal 2, the non-wearable terminal 2 measures the distance to the non-user. The distance measurement information obtained by a ranging sensor, if being mounted to the non-wearable terminal 2, may be used to measure the distance. If the ranging sensor is not mounted, an approximate distance may be estimated based on the image taken by the camera 206. In this case, it may be determined that the distance from the non-wearable terminal 2 to the user are substantially the same as that to the non-user, for example, in the case where the ratio of the size of the face of the non-user relative to the size of the face of the user corresponds to a predetermined ratio. Alternatively, the camera 106 or the ranging sensor 108 of the wearable terminal 1 may be used for image-capturing and distance measurement. In this case, the relation between the position and direction of the display 212 of the non-wearable terminal 2 and those of the non-user 360 is analyzed based on an image captured by the camera 106 and a result of distance measurement carried out by the ranging sensor 108.

The alternative display is executed when the distance from the non-wearable terminal 2 to the non-user is within a range of a first distance for determining whether the information being shown on the display 212 can be read. For example, the range of the first distance can be set to a distance that is substantially the same as the distance between the user and the non-wearable terminal 2.

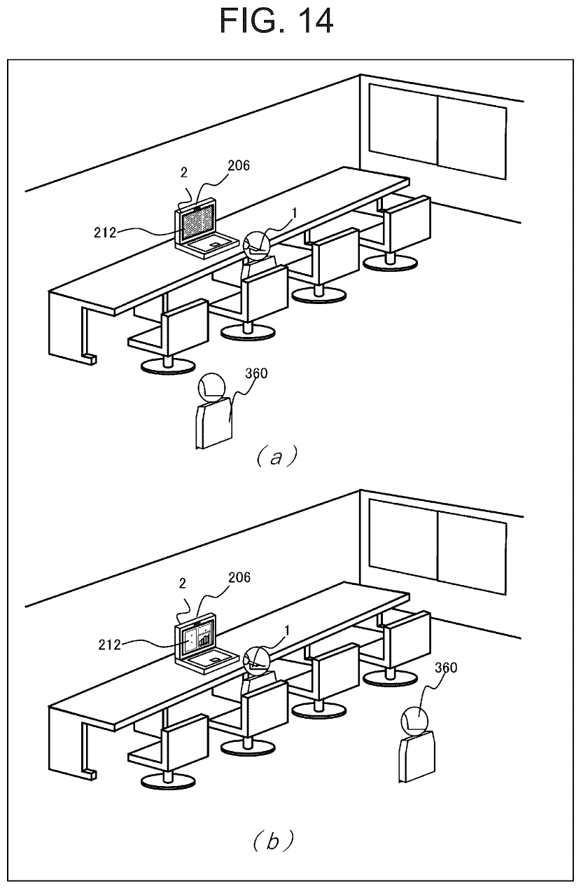

FIG. 14 illustrates an example of the alternative display control in the case where the non-user 360 is present in a place farther than the first distance, in which FIG. 14(a) illustrates an example of carrying out the alternative display and FIG. 14(b) illustrates an example of not carrying out the alternative display.

FIG. 14(a) illustrates the case where the non-user 360 is away from the range of the first distance with his or her face being at a place allowing the non-user 360 to see the display 212 of the non-wearable terminal 2. An image captured by the camera 206 of the non-wearable terminal 2 or the camera 106 of the wearable terminal 1 is analyzed, and if the non-user 360 is recognized in the image, the alternative display is carried out.

FIG. 14(b) illustrates the case where the non-user 360 is present away from the range of the first distance with his or her face being not visible from the display 212 of the non-wearable terminal 2. In this case, the information being shown on the display 212 is not likely to be read by the non-user 360 since the user blocks his or her view, and accordingly, the alternative display is not to be carried out.

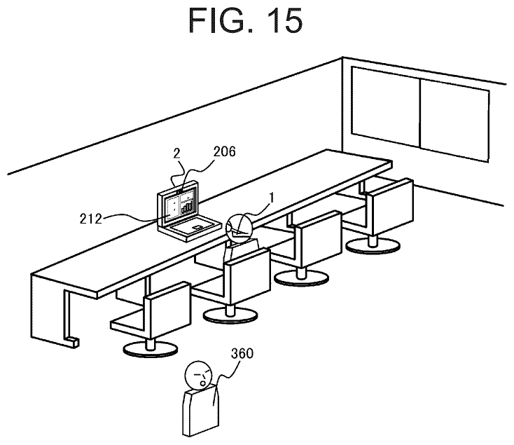

FIG. 15 illustrates an example of not carrying out the alternative display since the non-user 360 is present at a place farther than the first distance.

In FIG. 15, the non-user 360 is away from the range of the first distance. Furthermore, the non-user 360 has his or her back to the non-wearable terminal 2 and thus he or she cannot read the display data being shown on the display 212. In this case, the alternative display is not to be carried out.

As described above, the alternative display control can be carried out based on the presence or absence, position, and direction of the non-user 360 who is present near the user or the non-wearable terminal 2, as the information relating to an information leakage medium.

### Setting Screen

The setting of the alternative display is carried out on the wearable terminal 1, however, it may be carried out on the non-wearable terminal 2. In this case, the non-wearable terminal 2 may transmit the setting information to the wearable terminal 1 after establishing the pairing with the wearable terminal 1. FIG. 16 illustrates an example of a user setting screen of the alternative display function.

The setting screen 400 illustrated in FIG. 16 includes the following major items.
(1) “ALWAYS NOT APPLY (OFF)”
(2) “ALWAYS APPLY (ON)”
(3) “APPLY AS NEEDED”

The user is allowed to select an application pattern therefrom.

If the user selects (3) “APPLY AS NEEDED”, he or she is allowed to make selection from among the following items.
(3-1) Apply the alternative display function as needed based on an applicable place (“AUTOMATICALLY IDENTIFY APPLICABLE PLACE (INFORMATION SECURITY: LOW)”)
(3-2) Apply the alternative display function as needed based on an applicable target (“AUTOMATICALLY IDENTIFY APPLICABLE TARGET (INFORMATION LEAKAGE MEDIUM)”)

The user is allowed to select both the items above. For this case, the priority levels of the applicable place and applicable target may be set in a button 401 for “SET PRIORITY”. Using the priority levels, the alternative display can be controlled depending on whether any of the conditions is satisfied, or controlled by prioritizing one of the conditions. This can prevent the inconsistencies in the alternative display control, and realize the alternative display control in accordance with the priorities of the application conditions set by the user.

### (3-1) Automatically Identify Applicable Place (Information Security: Low)

In “AUTOMATICALLY IDENTIFY APPLICABLE PLACE (INFORMATION SECURITY: LOW)”, the user is allowed to select the following items.
(3-1-1) Exclude pre-registered places (“EXCLUDE REGISTERED PLACE (INFORMATION SECURITY: HIGH)”)
(3-1-2) “AUTOMATICALLY SELECT” applicable places
(3-1-3) “DESIGNATE PLACE TO BE AUTOMATICALLY IDENTIFIED”

### (3-1-1) Exclude Registered Place (Information Security: High)

In response to pressing of a button 402 for “REGISTER AND SET NON-APPLICABLE PLACE”, the position information and image of a place for which the alternative display control is not to be carried out, such as a home or a room, are acquired by the positioning sensor 107 or the camera 106 and registered in advance as a place with the information security being high. Upon selection of the “EXCLUDE REGISTERED PLACE (INFORMATION SECURITY: HIGH)”, the alternative display control is controlled not to be carried out at a pre-registered place based on the position information and image of the pre-registered place and those of the place where the user is currently present.

### (3-1-2) Automatically Select Place

A place for which the alternative display is to be carried out may be automatically selected (Automatic setting: whether the place where the user is currently present corresponds to the place similar to either of all the preset places (for example, coffee shops, in the trains, etc.) is automatically identified based on the preset position information and images to carry out the alternative display). This can realize the control of automatically selecting a place with the information security being low to carry out the alternative display therefor.

### (3-1-3) Designate Place to be Automatically Identified

The user may designate in advance places for which the identification and alternative display are to be automatically carried out. As spaces to be identified as applicable places, the items “COFFEE SHOP”, “LIBRARY”, “IN-CAR”, and “IN-TRAIN” are listed in FIG. 16, however, the user may add and set other places to be automatically identified by pressing a button 403 for “REGISTER AND SET PLACE TO BE AUTOMATICALLY IDENTIFIED”. This enables the control of automatically identifying whether the place where the user is currently present corresponds to a place similar to a specific place registered and designated by the user based on the registered position information and images to carry out the alternative display.

### (3-2) Automatically Identify Applicable Target (Information Leakage Medium)

In “AUTOMATICALLY IDENTIFY APPLICABLE TARGET (INFORMATION LEAKAGE MEDIUM)”, the user is allowed to select the following items.
(3-2-1) Automatically select target
(3-2-2) Designation target to be automatically identified (information leakage medium)

### (3-2-1) Automatically Select Target

The image captured by the camera 206 of the non-wearable terminal 2 or the camera 106 of the wearable terminal 1 may be analyzed so that an information leakage medium for which the alternative display is to be carried out can be automatically selected (Automatic setting: for all the pre-registered information leakage media (for example, a security camera, a person), identification and alternative display are automatically carried out based on the pre-registered images of the information leakage medium). This enables the control of automatically identifying the information leakage medium to carry out the alternative display therefor.

### (3-2-2) Designation Target to be Automatically Identified (Information Leakage Medium)

The image captured by the camera 206 of the non-wearable terminal 2 or the camera 106 of the wearable terminal 1 is analyzed so that the information leakage medium registered and designated in advance by the user can be automatically identified based on the image of the registered information leakage medium to carry out the alternative display (for example, a security camera and a person, and other objects such as a mobile terminal and the like can be added as applicable targets). This enables the control of automatically carrying out the identification and alternative display for the specific information leakage medium registered and designated in advance by the user. The user may press a button 404 for “REGISTER AND SET TARGET TO BE AUTOMATICALLY IDENTIFIED” to add an information leakage medium.

FIG. 17 illustrates a user setting screen of the detailed alternative display function.

In the user setting screen 410 of FIG. 17(a), the user is allowed to set the conditions for applying the detailed alternative display function. Specifically, the user can select whether to use, as the application condition, one of the conditions of the presence or absence of a “SHIELDING OBJECT” and the “GROUP TO WHICH PERSON OR USING DEVICE BELONGS”, or both of them.

The “SHIELDING OBJECT” can be applied in the case where the “AUTOMATICALLY IDENTIFY APPLICABLE PLACE (INFORMATION SECURITY: LOW)” has been selected in the setting screen 400 of FIG. 16.

The “GROUP TO WHICH PERSON OR USING DEVICE BELONGS” can be applied in the case where the items “DESIGNATE TARGET TO BE AUTOMATICALLY IDENTIFIED (INFORMATION LEAKAGE MEDIUM)” and “PERSON” have been selected in the setting screen 400 of FIG. 16. In the case where “PERSON” has been selected, a person in the surrounding who is not the user and does not belong to the group is identified, and the alternative display is to be carried out.

In response to pressing of a button 411 for “REGISTER AND SET GROUP INFORMATION”, the group information registration setting screen 420 illustrated FIG. 17(b) opens. In the group information registration setting screen 420, the user edits the group information for each person and each using device, and presses a button 421 for “REGISTER AND SET” to proceed to a group information details screen 430 illustrated in FIG. 18. Each of FIG. 17(b) and FIG. 18 illustrates an example in which the information about “GROUP TO WHICH PERSON OR USING DEVICE BELONGS” is classified for each group, however, the information about “GROUP TO WHICH PERSON OR USING DEVICE BELONGS” does not necessarily have to be classified as described above, but may be, for example, classified for each person and for each using device.

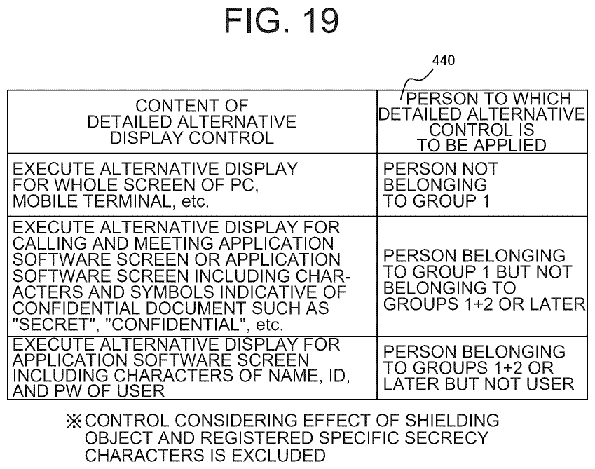

FIG. 18 illustrates a group information registration setting screen. In the following, each item of the group information details screen 430 will be described.
(1) Group name . . . An arbitrary name of group.
(2) Group information . . . A specific group (company (including information on departments, etc.), family, club activity, or the like. For carrying out the alternative display control illustrated in FIG. 19 which will be described later, the group information is preferably defined in several classes.
(3) Group member . . . A person who belongs to the group (Individual identification information, such as an image or audio data, used to uniquely identify the person is registered).
(4) Using device . . . A device used in the group (PC, mobile terminals, or the like).
(5) Specific secrecy characters for hiding information from non-group member . . . Specific secrecy characters (XXX section, YY meeting, etc.).
(6) Application condition for detailed alternative display function

The group information details screen 430 includes “REGISTER AND SET BUTTONS” 431, 432, 433, 434, 435 for registering each item of (1) Group name, (2) Group information, (3) Group member, (4) Using device, and (5) Specific characters to be hidden from non-group member after being edited.

In (6) “APPLICATION CONDITION FOR DETAILED ALTERNATIVE DISPLAY FUNCTION” described above, the user is allowed to select the following items.
(6-1) “IDENTIFY NON-GROUP MEMBER (BASED ON USER)”
(6-2) “IDENTIFY NON-GROUP MEMBER (BASED ON USING DEVICE)”
(6-1) “IDENTIFY NON-GROUP MEMBER (BASED ON USER)”

Whether a person who is near the user using a PC or the like belongs to the same group as that of the user is determined, and the alternative display control is carried out based on the result of determination.
(6-2) “IDENTIFY NON-GROUP MEMBER (BASED ON USING DEVICE)”

Whether a person who is near the user using a device such as a PC belongs to the same organization (group) that manages the device is determined, and the alternative display control is carried out based on the result of determination.

In both the identification based on the user and that based on the using device, in response to the selection of the “SPECIFIC SECRECY CHARACTERS FOR HIDING INFORMATION FROM NON-GROUP MEMBER”, the alternative display is carried out for a screen such as a screen of an application software including the specific secrecy characters for hiding information from a non-group member.

This enables the detailed alternative display control to be carried out depending on the relationship between the user or the device being used by the user and a surrounding person other than the user.

FIG. 19 illustrates an example of alternative display control rule information including rules to be applied in the case where any one of the following items, “GROUP TO WHICH PERSON OR DEVICE BELONGS” in the screen illustrated in FIG. 17(a), “IDENTIFY NON-GROUP MEMBER (BASED ON USER)” in the screen illustrated in FIG. 18, or “IDENTIFY NON-GROUP MEMBER (BASED ON USING DEVICE)” in the screen illustrated in FIG. 18, is selected.

In alternative display control rule information 440 illustrated in FIG. 19, “GROUP 1” and “GROUP 2” correspond to the classes of the group as defined in FIG. 18. FIG. 19 illustrates that the classes of the group are associated with the contents of the alternative display control.

For example, in the first line of FIG. 19, execution of the alternative display for the whole screen is associated with “PERSON NOT BELONGING TO GROUP 1”, in other words, a person who is not an employee of the company.

In the second line of FIG. 19, execution of the alternative display for a screen of an application software for calling and meeting and a screen of an application software including characters or symbols indicating that the document is confidential is associated with “PERSON BELONGING TO GROUP 1 BUT NOT BELONGING TO GROUPS 1+2 or later”, in other words, a person who is an employee of the company but belongs to a different department.

In the third line of FIG. 19, execution of the alternative display for the private information about the user is associated with a “PERSON BELONGING TO GROUPS 1+2 or later BUT NOT USER”, in other words, a person who is an employee of the company and belongs to the same department as the user, assuming that the person belonging to the same department owes substantially the same duty of confidentiality as the user. The private information about the user corresponds to a screen of an application software including the name, ID, and password characters of the user.

### Alternative Display Control Procedure

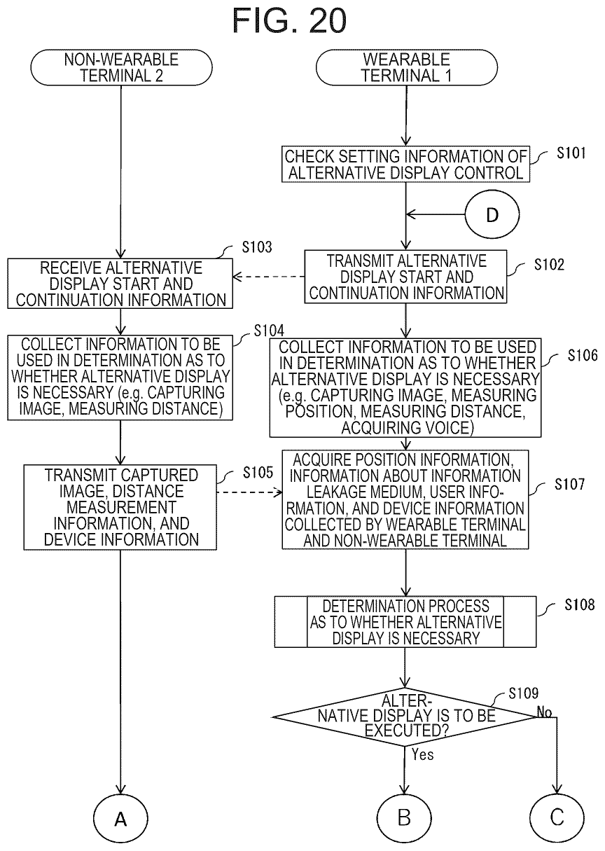

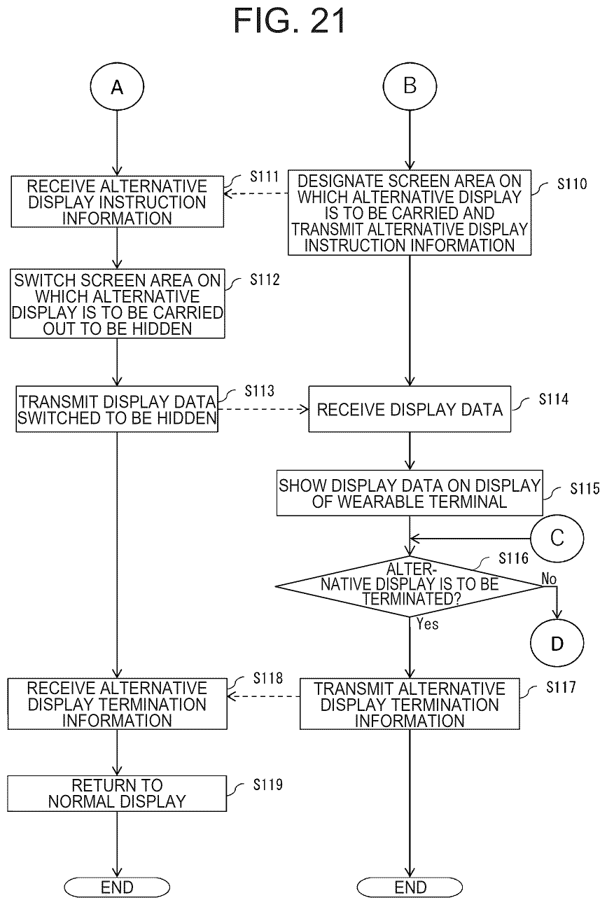

FIG. 20 illustrates a flowchart of a flow of the processing (first half) of the alternative display system according to the present embodiment, and FIG. 21 illustrates a flowchart of a flow of the processing (second half) of the alternative display system according to the present embodiment.

In response to the start of the alternative display control by the wearable terminal 1, the alternative display controlling section 125 checks the setting information (S101).

For the case where a plurality of conditions for applying the alternative display function is set, a process of step S108, which will be described later, for determining whether the alternative display is necessary in accordance with the order set in the “SET PRIORITY” of FIG. 16 is carried out. Accordingly, the setting information about the priorities also needs to be acquired in step S101. For the case where a plurality of application conditions has been set although the priorities have not been set, it may be set to determine whether the alternative display is necessary using the application conditions in accordance with a predetermined order.

If “ALWAYS NOT APPLY” has been set, the processing is terminated. If “ALWAYS APPLY” or “APPLY AS NEEDED” has been set, the alternative display controlling section 125 transmits alternative display start and continuation information to the non-wearable terminal 2 (S102).

The alternative display start and continuation information further includes request information for the data necessary in making determination as to the application conditions of the alternative display set in the setting information (see FIG. 16). For example, if “SECURITY CAMERA” is included in “AUTOMATICALLY IDENTIFY APPLICABLE TARGET (INFORMATION LEAKAGE MEDIUM)”, the alternative display start and continuation information includes a request for the non-wearable terminal 2 to capture images.

If “PERSON” is included in “AUTOMATICALLY IDENTIFY APPLICABLE TARGET (INFORMATION LEAKAGE MEDIUM)”, the alternative display start and continuation information may include, in addition to the request for the non-wearable terminal 2 to capture images, a request for the non-wearable terminal 2 to acquire the distance information if it is equipped with a ranging sensor.

The non-wearable terminal 2 receives the alternative display start and continuation information (S103), and based on the information as received, collects the information to be used in determination as to whether the alternative display is necessary (S104).

In the non-wearable terminal 2, if capturing images using the camera 206 mounted to the non-wearable terminal 2 and measurement of a distance to a person, as an information leakage medium, need to be carried out, a distance to the person whose image has been captured is measured (S104) and transmitted to the wearable terminal 1 (S105).

If “ALWAYS APPLY” has been selected, after the transmission and reception of the alternative display start and continuation information (S102, S103), the display 212 of the non-wearable terminal 2 is switched to the non-display state (skipped to S112).

The wearable terminal 1 also collects the information to be used in the determination as to whether the alternative display is necessary (S106). In the wearable terminal 1, in addition to image-capturing, distance measurement, and acquisition of the position information by positioning sensor 107, the voices of the user are acquired using the microphone 113 within a range necessary for the determination as to whether the alternative display is necessary.

The wearable terminal 1 acquires the information collected by the wearable terminal 1 and the non-wearable terminal 2, including the information about the place where the user is present (position information detected by the positioning sensor 107, images captured by the camera 106 and the camera 206), the information about a surrounding information leakage medium (images captured by the cameras 106, 206), the user information (user's group information read from the setting information of the wearable terminal 1, audio data acquired using the microphone 113, etc.), and the device information received from the non-wearable terminal 2 (S107), and uses the acquired information in a determination process as to whether the alternative display is necessary (S108). The determination process as to whether the alternative display is necessary (S108) will be described later.

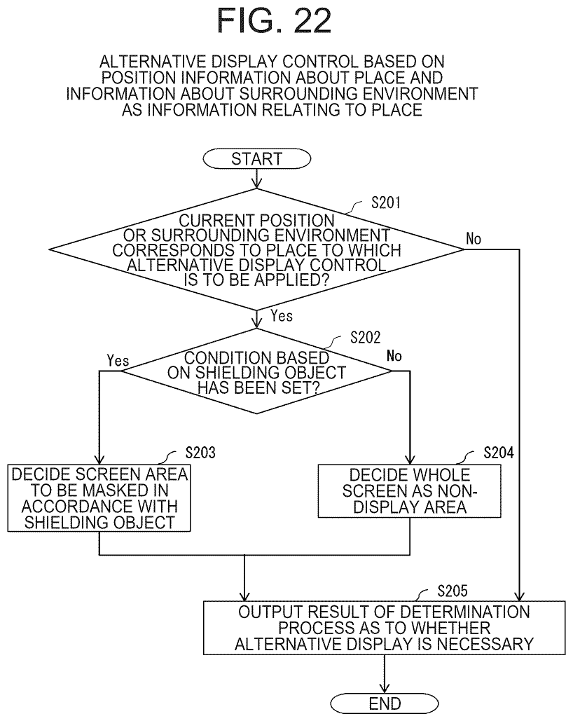

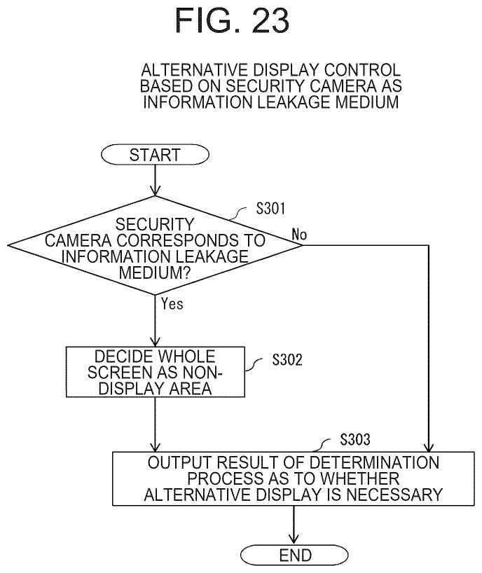

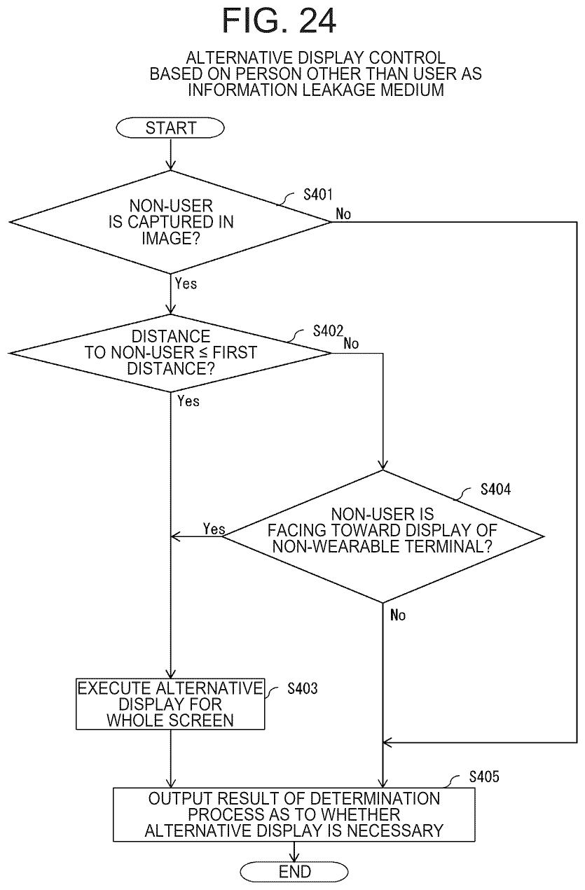

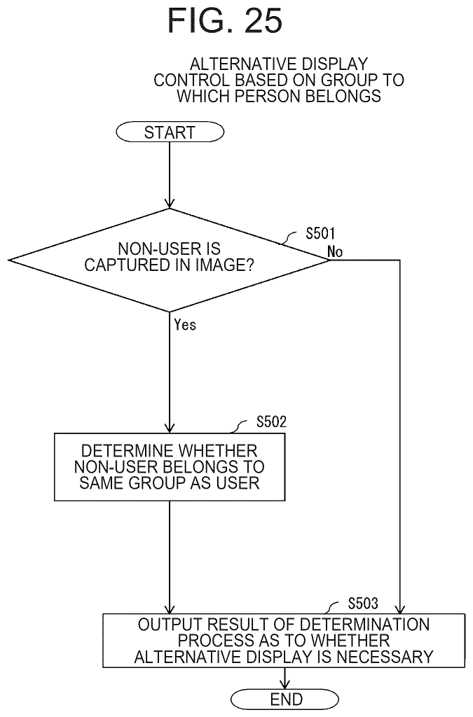

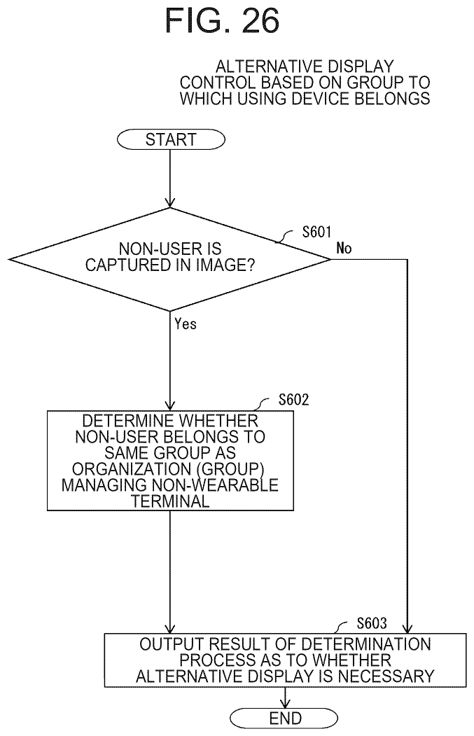

The determination process as to whether the alternative display is necessary includes “ALTERNATIVE DISPLAY CONTROL BASED ON POSITION INFORMATION ABOUT PLACE AND INFORMATION ABOUT SURROUNDING ENVIRONMENT AS INFORMATION RELATING TO PLACE” (FIG. 22), “ALTERNATIVE DISPLAY CONTROL BASED ON SECURITY CAMERA AS INFORMATION LEAKAGE MEDIUM” (FIG. 23), “ALTERNATIVE DISPLAY CONTROL BASED ON PERSON OTHER THAN USER AS INFORMATION LEAKAGE MEDIUM” (FIG. 24), “ALTERNATIVE DISPLAY CONTROL BASED ON GROUP TO WHICH PERSON BELONGS” (FIG. 25), and “ALTERNATIVE DISPLAY CONTROL BASED ON GROUP TO WHICH USING DEVICE BELONGS” (FIG. 26). These controls are processed in accordance with the priorities read in S101.

As a result of the determination process as to whether the alternative display is necessary, for the case where the alternative display is to be carried out (S109: Yes), the wearable terminal 1 designates a screen area for which the alternative display is to be carried out and transmits alternative display instruction information indicative of the screen area to the non-wearable terminal 2 (S110).

The non-wearable terminal 2 receives the alternative display instruction information (S111), and switches the screen area for which the alternative display is to be carried out to be hidden (S112). Furthermore, the non-wearable terminal 2 transmits the display data 300 which has been hidden to the wearable terminal 1 (S113), and the wearable terminal 1 receives the display data 300 (S114).

The wearable terminal 1 displays the information relating to the alternative display as received on the display 112 of the wearable terminal 1 (S115). For the case where the alternative display is to be continued (S116: No), the processing returns to step S102 and each of the non-wearable terminal 2 and the wearable terminal 1 collects information to be used in the determination process as to whether the alternative display is necessary. If “ALWAYS APPLY” has been selected, the processing returns to S112.

For the case where the alternative display control is to be terminated (S116: Yes), the wearable terminal 1 transmits alternative display termination information to the non-wearable terminal 2 (S117), and the non-wearable terminal 2 receives the alternative display termination information (S118).

The non-wearable terminal 2 returns from the non-display state to the normal-display state (S119), and also stops transmitting the display data to the wearable terminal 1. This causes the alternative display control in the wearable terminal 1 and the non-wearable terminal 2 to be ended.

### Alternative Display Control Based on Position Information About Place and Information About Surrounding Environment as Information Relating to Place

FIG. 22 illustrates a flowchart of a flow of the processing of the alternative display control based on position information about a place and information about a surrounding environment as information relating to the place.

The alternative display controlling section 125 acquires the position information about the user measured by the positioning sensor 107, the image including the surrounding environment captured by the camera 206 or camera 106, and the distance information measured by the ranging sensor 108 to determine whether the current position or the surrounding environment corresponds to the place to which the alternative display control is to be applied by referring to the setting information (S201). When the result of determination is negative (S201: No), the alternative display controlling section 125 outputs a result of the determination process as to whether the alternative display is necessary is output (S205) so that the flow proceeds to the processing for the case where the alternative display is not to be executed (S109: No).

When the result of determination is positive (S201: Yes), the alternative display controlling section 125 refers to the setting information. If the condition based on a shielding object has been set (S202: Yes), the image recognizing section 121 analyzes the image captured by the camera 106 of the wearable terminal 1 or the camera 206 of the non-wearable terminal 2 to detect the shielding object, and the shielding object determining section 122 determines an area of the screen to be hidden in accordance with the shielding object (S203). Then, the shielding object determining section 122 outputs a result of determination process as to whether the alternative display is necessary (S205) so that the flow proceeds to the processing for the case where the alternative display is to be executed (S109: Yes). In the image analysis mentioned above, the image recognizing section 121 detects an area of the image in which the shielding object is captured. Then, the shielding object determining section 122 decides an area of the screen to be hidden in accordance with the height, non-transparency, and position of arrangement of the shielding object.

If a condition based on a shielding object has not been set (S202: No), the shielding object determining section 122 decides the whole of the display 212 of the non-wearable terminal 2 as a non-display area (S204), and the alternative display controlling section 125 outputs a result of determination process as to whether the alternative display is necessary (S205) so that the flow proceeds to the processing for the case where the alternative display is to be executed (S109: Yes).

Thus, whether the alternative display control is necessary based on the position information about a place and the information about a surrounding environment can be determined, and furthermore, a non-display area can be decided in accordance with the height of a shielding object or the like as the information about the environment around the place.

### Alternative Display Control Based on Security Camera as Information Leakage Medium

FIG. 23 illustrates a flowchart of a flow of the processing of the alternative display control based on a security camera as an information leakage medium.

The image recognizing section 121 analyzes an image captured by the camera 106 of the wearable terminal 1 or an image captured by the camera 106 of the non-wearable terminal 2 to detect a security camera, and the information leakage medium determining section 124 determines whether the security camera corresponds to an information leakage medium in accordance with the position and direction of the security camera (S301). When the result of determination is negative (S301: No), a result of the determination process as to whether the alternative display is necessary is output (S303) so that the flow proceeds to the processing for the case where the alternative display is not to be executed (S109: No).

When the result of determination result is positive (S301: Yes), the information leakage medium determining section 124 decides to hide the whole screen of the display 212 of the non-wearable terminal 2 (S302), and the alternative display controlling section 125 outputs a result of the determination process as to whether the alternative display is necessary (S303) so that the flow proceeds to the processing for the case where the alternative display is to be executed (S109: Yes).

As described above, the alternative display is carried out based on the position and direction of a security camera in case that there is a risk of the leakage of information being shown on the display 212 of the non-wearable terminal 2 via the security camera, which enables enhancement of the level of information security.

### Alternative Display Control Based on Person Other Than User as Information Leakage Medium

FIG. 24 illustrates a flowchart of a flow of the processing of the alternative display control based on a person other than the user as an information leakage medium.

The image recognizing section 121 analyzes an image captured by the camera 206 of the non-wearable terminal 2 or the camera 106 of the wearable terminal 1 to determine whether a non-user is captured in the image (S401). When the result of the determination is negative (S401: No), a result of the determination process as to whether the alternative display is necessary is output (S405) so that the flow proceeds to the processing for the case where the alternative display is not to be executed (S109: No).

When the result of the determination is positive (S401: Yes), the information leakage medium determining section 124 determines whether the distance from the non-wearable terminal 2 to the non-user is within the first distance range for determining whether the information being shown on the display 212 can be read (S402). When the result of the determination is positive (S402: Yes), the information leakage medium determining section 124 decides to hide the whole screen of the display 212 (S403), and the alternative display controlling section 125 outputs a result of the determination process as to whether the alternative display is necessary (S405) so that the flow proceeds to the processing for the case where the alternative display is to be executed (S109: Yes).

When the distance from the non-wearable terminal 2 to the non-user is not within the first distance range (S402: No), and if the face of the non-user is being directed to the display 212 (S403), the information leakage medium determining section 124 decide to hide the whole screen (S404: Yes), and the alternative display controlling section 125 outputs a result of the determination process as to whether the alternative display is necessary (S405) so that the flow proceeds to the processing for the case where the alternative display is to be executed (S109: Yes).

On the other hand, when the distance from the non-wearable terminal 2 to the non-user is not included within the first distance range (S402: No), and if the face of the non-user is not being directed to the display 212 (S404: No), the information leakage medium determining section 124 outputs a result of the determination process as to whether the alternative display is necessary (S405) so that the flow proceeds to the processing for the case where the alternative display is not to be executed (S109: No).

As described above, the alternative display is carried out for the case where a non-user is present near the user or the face of the non-user is being directed to the display 212 of the non-wearable terminal 2, which enables enhancement of the level of information security.

### Alternative Display Control Based on Group to Which Person Belongs

FIG. 25 illustrates a flowchart of a flow of the processing of the alternative display control based on a group to which a person belongs.

The image recognizing section 121 analyzes an image captured by the camera 206 of the non-wearable terminal 2 or the camera 106 of the wearable terminal 1 to determine whether a non-user other than the user is captured in the image (S501). When the result of the determination is negative (S501: No), a result of the determination process as to whether the alternative display is necessary is output (S503) so that the flow proceeds to the processing for the case where the alternative display is not to be executed (S109: No).

When the result of the determination is positive (S501: Yes), the alternative display controlling section 125 refers to the group information that has been set on the group information details screen 430 (see FIG. 18) to determine whether the group to which the non-user belongs is the same as the group to which the user belongs (S502). Then, the alternative display controlling section 125 refers to the alternative display control rule information 440 (see FIG. 19) to decide the content of the alternative display control, and outputs a result of the determination process as to whether the alternative display is necessary (S503) so that the flow proceeds to the processing for the case where the alternative display is to be executed (S109: Yes).

As described above, for the case where the non-user is present near the user, the alternative display is carried out in accordance with groups to which a non-user and the user belong, which enables enhancement of the level of information security.

### Alternate Display Control Based on Group to Which Using Device Belongs

FIG. 26 illustrates a flowchart of a flow of the processing of the alternative display control based on a group to which a person belongs.

The image recognizing section 121 analyzes an image captured by the camera 206 of the non-wearable terminal 2 or the camera 106 of the wearable terminal 1 to determine whether a non-user other than the user is captured in the image (S601). When the result of the determination is negative (S601: No), a result of the determination process as to whether the alternative display is necessary is output (S603) so that the flow proceeds to the processing for the case where the alternative display is not to be executed (S109: No).

When the result of the determination is positive (S601: Yes), the alternative display controlling section 125 refers to the group information that has been set on the group information details screen 430 (see FIG. 18) to determine whether the organization (group) to which the non-user belongs is the same as the organization managing the non-wearable terminal 2 (S602). Then, the alternative display controlling section 125 refers to the alternative display control rule information 440 (see FIG. 19) to decide the content of the alternative display control, and outputs a result of the determination process as to whether the alternative display is necessary (S603) so that the flow proceeds to the processing for the case where the alternative display is to be executed (S109: Yes).

As described above, the alternative display is carried out for the case where a non-user who does not belong to an organization (group) that manages a non-wearable terminal is present nearby, which enables enhancement of the level of information security.

According to the present embodiment, in accordance with a place where the user is using a non-wearable terminal or a surrounding situation of the user (necessity of the alternative display), the display of a non-wearable terminal is switched to show a dark screen or a mask screen while the information to be prevented from leaking is shown on the display of a wearable terminal. This enables prevention of the leakage of information which may be caused by a non-user who sneaks a look or secretly sees the screen of the display of the non-wearable terminal, and also to enhancement of the level of information security of the non-wearable terminal.

The present embodiment is not intended to limit the scope of the present invention thereby, and any combination of the examples described in the embodiment above is included in the present invention. Furthermore, the present invention may include such a modification that adds a function to the embodiment described above.

For example, in the present embodiment, the alternative display program 120 is installed in the wearable terminal 1, however, it may be installed in the non-wearable terminal 2. In this case, the non-wearable terminal 2 may determine whether to execute the alternative display control after establishing the connection with the wearable terminal 1.

Furthermore, the non-display processing for the display 212 of the non-wearable terminal 2 according to the present embodiment may include the control of the luminance of the display 212 of the non-wearable terminal 2, masking processing, mosaic processing, and the like.

Still further, the numerical values and messages appearing in the text and drawings are merely examples, and thus the advantageous effects of the present invention would not be impaired even if different ones are used.

Still further, each of the programs described in the examples of the processing may be an independent program, or a plurality of programs may configure one application program. Still further, the orders of execution of the processes may be changed.

Some or all of the functions and the like of the present invention described above may be implemented by hardware, for example, by designing them with an integrated circuit, a general-purpose processor, or a specific-purpose processor. The processor includes transistors and other circuits, and may be considered as circuitry or processing circuitry. Furthermore, the functions may be implemented by software in such a manner that a processor unit interprets and executes an operation program for realizing the respective functions or the like. Alternatively, they may be implemented by a combination of hardware and software.

The control lines and information lines which are considered to be necessary for the purpose of explanation are indicated herein, but not all the control lines and information lines of actual products are necessarily indicated. It may be considered that almost all the components are actually connected to each other.

The embodiment described above includes the following aspects.

### First Aspect

A wearable terminal comprising:
a display;
a transceiver configured to receive display data of a non-wearable terminal;
a memory; and
a processor,
the processor being configured to:
   transmit, to the non-wearable terminal via the transceiver, a control signal for causing the display data as received to be hidden; and
   execute alternative display control of receiving the display data of the non-wearable terminal to display the display data on the display.

### Second Aspect

A linked display system comprising:
a wearable terminal; and
a non-wearable terminal,
the wearable terminal including:
   a first display;
   a first transceiver configured to receive display data of the non-wearable terminal; and
   a first processor;
the non-wearable terminal including:
   a second display;
   a second transceiver configured to transmit the display data to the wearable terminal; and
   a second processor,
the first processor being configured to execute alternative display control by transmitting, to the non-wearable terminal via the first transceiver, a control signal for causing the display data to be hidden, receiving the display data of the non-wearable terminal, and showing the display data on the first display, and
the second processor being configured to receive the control signal via the second transceiver, hide the display data on the second display, and transmit the display data to the wearable terminal.

### Third Aspect

A linked display method to be executed between a wearable terminal and a non-wearable terminal, comprising:
from the wearable terminal to the non-wearable terminal, transmitting a control signal for causing display data being shown on a display of the non-wearable terminal to be hidden;
hiding the display data on the display of the non-wearable terminal and also transmitting the display data to the wearable terminal;
receiving the display data by the wearable terminal from the non-wearable terminal; and
showing the display data on a display provided in the wearable terminal.

### Reference Signs List

1: wearable terminal, 2: non-wearable terminal, 2A: laptop, 2C: mobile terminal, 4: server, 5: external network, 10: alternative display system,
100: HMD, 100s: AR glasses, 101: processor, 102: memory, 103: storage, 104: operation input interface, 106: camera, 107: positioning sensor, 108: ranging sensor, 109: acceleration sensor, 110: gyro sensor, 111: geomagnetic sensor, 112: display, 113: microphone, 114: speaker, 115: timer, 116: network transceiver, 117: BT transceiver, 118: bus, 120: alternative display program, 121: image recognizing section, 122: shielding object determining section, 123: non-display area deciding section, 124: information leakage medium determining section, 125: alternative display controlling section, 126: display data receiving section, 127: virtual reality object displaying section, 130: data, 131: place information, 132: information leakage media information, 133: alternative display control information, 140: display or non-display switching program, 141: display or non-display switching section, 142: display data transmitting section
201: processor, 202: memory, 203: storage, 204: operation input interface, 206: camera, 212: display, 212A: display, 212B: display, 212C: display, 216: network transceiver, 217: BT transceiver, 218: bus
300: display data, 301: application screen, 320: shielding object, 320a: shielding object, 320b: shielding object, 350: security camera, 360: non-user, 400: setting screen, 401: button for setting priority, 402: button for registering and setting non-applicable place, 403: button for registering and setting place to be automatically identified, 404: button for registering and setting place to be automatically identified, 410: user setting screen, 411: button for registering and setting group information, 420: group information registration setting screen, 421: register and set button, 430: group information details screen, 431: register and set button, 432: register and set button, 433: register and set button, 434: register and set button, 435: register and set button, 440: alternative display control rule information

1. A wearable terminal comprising:
a display;
a transceiver configured to receive display data of a non-wearable terminal;
a memory; and
a processor,
the processor being configured to:
transmit, to the non-wearable terminal via the transceiver, a control signal for causing the display data as received to be hidden based on information about a place or information about an information leakage medium stored in the memory; and
execute alternative display control of receiving the display data of the non-wearable terminal to display the display data on the display.

2. The wearable terminal according to claim 1, further comprising:
a positioning sensor configured to detect position information; and
a camera for capturing an image of a surrounding environment, wherein
the memory retains, as the information about the place, the position information detected by the positioning sensor or the image captured by the camera.

3. The wearable terminal according to claim 2, wherein
the memory retains, as pre-registration information for executing the alternative display control, the position information detected by the positioning sensor or the image captured by the camera, and
the processor executes the alternative display control upon determining that a place where a user is present is not recorded in the pre-registration information.

4. The wearable terminal according to claim 2, wherein
the processor is configured to:
analyze the image captured by the camera to recognize a shielding object located around the display of the non-wearable terminal; and
decide, within the display of the non-wearable terminal, a screen area to be hidden in accordance with at least one of a height of the shielding object, a transparency of the shielding object, or a position of the shielding object relative to the non-wearable terminal.

5. The wearable terminal according to claim 1, further comprising a camera, wherein
the processor is configured to:
analyze at least one or more of an image captured by the camera and an image captured by a camera mounted on the non-wearable terminal to recognize an information leakage medium located around the display of the non-wearable terminal based on the information about the information leakage medium, and
execute the alternative display control in accordance with at least one of a position or a direction of the information leakage medium relative to the non-wearable terminal.

6. The wearable terminal according to claim 5, wherein
the information leakage medium is a security camera or a non-user who is different from the user of the wearable terminal.

7. The wearable terminal according to claim 5, wherein
the memory retains user information in which an organization to which a user of the wearable terminal belongs is associated with identification information about a non-user who belongs to the organization, and
the processor analyzes the image captured by the camera to make a determination as to whether a person captured by the camera is the same as the non-user who belongs to the organization to which the user belongs included in the user information, and executes the alternative display control based on a result of the determination.

8. The wearable terminal according to claim 5, wherein the memory retains user information in which an organization to which a user of the wearable terminal belongs is associated with identification information about a non-user who belongs to the organization, and
the processor analyzes the image captured by the camera, checks a person captured by the camera with the user information, makes a determination as to whether the organization to which the person captured by the camera belongs is the same as the organization to which the user belongs, and executes the alternative display control based on a result of the determination.

9. The wearable terminal according to claim 5, wherein
the memory retains group information about a using device in which an organization managing the wearable terminal is associated with identification information about a non-user who belongs to the organization, and
the processor analyzes the image captured by the camera, checks a person captured by the camera with the group information about the using device, makes a determination as to whether the organization to which the person captured by the camera belongs is the same as the organization managing the wearable terminal, and executes the alternative display control based on a result of the determination.

10. A linked display system comprising:
a wearable terminal; and
a non-wearable terminal,
the wearable terminal including:
a first display;
a first transceiver configured to receive display data of the non-wearable terminal; and
a first processor;
the non-wearable terminal including:
a second display;
a second transceiver configured to transmit the display data to the wearable terminal; and
a second processor,
the first processor being configured to execute alternative display control by transmitting, to the non-wearable terminal via the first transceiver, a control signal for causing the display data to be hidden, receiving the display data of the non-wearable terminal, and showing the display data on the first display, and
the second processor being configured to receive the control signal via the second transceiver, hide the display data on the second display, and transmit the display data to the wearable terminal.

11. The linked display system according to claim 10, wherein
the wearable terminal further includes a memory, and
the first processor executes the alternative display control based on information about a place or information about an information leakage medium stored in the memory.

12. A linked display method to be executed between a wearable terminal and a non-wearable terminal, comprising:
from the wearable terminal to the non-wearable terminal, transmitting a control signal for causing display data being shown on a display of the non-wearable terminal to be hidden based on information about a place or information about an information leakage medium stored in a memory of the wearable terminal;
hiding the display data on the display of the non-wearable terminal and also transmitting the display data to the wearable terminal;
receiving the display data by the wearable terminal from the non-wearable terminal; and
showing the display data on a display provided in the wearable terminal.
